(19) United States
(12) Patent Application Publication
(10) Pub. No.: US 2019/0195070 A1
(43) Pub. Date: Jun. 27, 2019

(54) SEALING PROFILE FOR EMBEDDING INTO A MOULDING OF CURABLE MATERIAL

(71) Applicant: Daetwyler Sealing Technologies Deutschland GmbH, Waltershausen (DE)

(72) Inventors: Matthias Klug, Eisenach (DE); Matthias Stender, Gotha (DE)

(21) Appl. No.: 16/306,681

(22) PCT Filed: Jun. 12, 2017
(86) PCT No.: PCT/DE2017/200051

§ 371 Date: Dec. 3, 2018

(30) Foreign Application Priority Data
Jun. 15, 2016 (DE) 10 2016 110 989.4

(51) Int. Cl. E21D 11/38; E21D 11/08

(52) U.S. Cl. CPC E21D 11/385; F16J 15/061; E21D 11/083

(57) ABSTRACT

A sealing profile for embedding into a moulding of curable material, in particular a concrete or plastic moulding, and to a sealing arrangement comprising such a sealing profile. The object of the present invention is to provide a sealing profile for embedding into a moulding of curable material that can be anchored into the moulding in particular such that displacements of the seal in its seat occur to a significantly lesser extent, if at all, when installing or assembling the mouldings. The object is achieved by a sealing profile (1) with a profile region (2) having a profile region surface (4) which is directed towards the moulding (3) after embedding the sealing profile (1). The profile region (2) has, at least in a subregion (6), fibres (5) which are fixedly connected to the sealing profile (1) and extend beyond the profile region surface (4).

The invention relates to a sealing profile for embedding into a moulding of curable material, in particular a concrete or plastic moulding, and to a sealing arrangement comprising such a sealing profile.

Shaft and tunnel structures are often composed of individual monolithic prefabricated parts (tubbing elements) between which contact joins are present, which are sealed with suitable seals to prevent, for example, the ingress of the surrounding medium (e.g. water). The production of such tubbing elements generally takes place with the aid of formwork moulds, as are known, for example, from DE 4218710 C1, DE 10 2007 032 236 A1 or DE 19841047 C1. A curable material, e.g. concrete, is poured into the formwork mould, which is opened and removed after the material has cured. After a moulding has cured, seals for sealing the contact joins can be arranged in peripheral grooves provided therefor in the butt faces of the prefabricated parts. An example of such a seal is described in DE 2833345 A1. However, the seals which are necessary for sealing the joins which are produced later when the prefabricated parts are assembled to form a shaft or tunnel are often already integrated into the prefabricated parts during casting by being cast in and anchored.

Seals intended for embedding into prefabricated parts are generally provided with what are known as anchoring feet which are enclosed by the curable material during casting of a prefabricated part and are used to hold the seal reliably in the cured prefabricated part. Nevertheless, the seal is still displaced in the prefabricated part when the prefabricated parts, e.g. tubbing elements, are installed. In particular in the case of frame-like seals as are often used in tunnel tubbing elements for tunnel construction, deformation of the seal in the region of the frame corners, for example, can occur thereby.

The object of the present invention is to provide a sealing profile for embedding into a moulding of curable material which does not have the disadvantages of known sealing profiles and can in particular be anchored in the moulding such that displacement of the seal in its seat does not occur or occurs to a greatly reduced extent when the prefabricated parts are installed or assembled.

The object is achieved by the subjects of the independent claims. Expedient embodiments of the invention are defined in the dependent claims.

In a first aspect, the present invention provides a sealing profile for embedding into a moulding of curable material, in particular a concrete or plastic moulding, for example a concrete tubbing element or a plastic pipe, wherein the sealing profile has a profile region having a profile region surface which faces the moulding after the sealing profile has been embedded, and wherein the sealing profile has, at least in a portion of the profile region, fibres which are fixedly connected to the sealing profile and extend beyond the profile region surface.

It was found that the displacements of tubbing seals observed in practice can be largely avoided if the sealing profile is anchored in the moulding at least additionally with fibres which are fixedly connected to a region of the sealing profile. It is assumed that the displacements of integrated seals observed in practice are attributable to the fact that the anchoring feet, in particular in the case of strand-like sealing profiles, are continuous in the longitudinal direction of the profile and cannot fully withstand application of force in this direction, and therefore displacements and for example compression of the seal in its seat can occur. The key concept of the present invention is therefore that of preventing such displacements and generally improving the adhesion of the seal to the moulding in that fibres which are fixedly connected to a profile part of the sealing profile are embedded into the moulding either instead of or additionally to at least one anchoring foot.

A “tubbing element” means prefabricated parts of the outer shell of tunnels, shafts, pipes etc. It can be for example an annular segment-shaped or annular part, e.g. consisting of concrete.

A “curable material” means in this case an initially flowable material which can be cured subsequently by itself under normal conditions or under external influences, e.g. of heat, UV light etc. It can be, for example, concrete, synthetic resin, adhesive and similar. It can also be, for example, a fibre-containing synthetic resin which cures to form a fibre-reinforced plastic, for example GRP.

A “sealing profile” in this case means a preferably strand-like and/or annular elastomer profile with a sealing function, for example a tubbing seal, concrete or plastic pipe seal or shaft seal. An “elastomer profile” is a profile consisting of elastomer material. Examples of suitable elastomer materials are natural rubber (NR), styrene-butadiene rubber (SBR), butyl rubber (IIR), ethylene-propylene diene monomer rubber (EPDM), nitrile butadiene rubber (NBR), hydrogenated nitrile butadiene rubber (HNBR), chloroprene rubber (CR), chlorosulphonated polyethylene (CSM), polyacrylic rubber (ACM), polyurethane rubber (PU), silicone rubber (Q), fluorosilicone rubber (MFQ) and fluoro rubber (FPM). EPDM, SBR, CR or NBR are preferred, NBR is particularly preferred, the elastomer material preferably having a Shore hardness of 60-80°. Mixtures of elastomers, for example of those mentioned above, are also possible. A sealing profile can also consist of different elastomer materials in some regions. For example, the back part of a tubbing profile, i.e. the profile region by which the profile is inserted into a formwork mould, can consist of a different, for example harder, elastomer material from the basis of the profile, or vice versa. Profiles which have regions consisting of different elastomer materials can be produced by coextrusion, for example.

The term “integrated seal” in this case means a sealing profile which is intended for embedding into a moulding consisting of curable material and designed correspondingly, e.g. is provided with at least one anchoring foot or other means for embedding the sealing profile into the curable material.

An “anchoring foot” in this case means a profile protrusion which projects into the subsequent moulding and effects a form fit between the profile and the moulding such that the profile is fastened to or in the cured moulding such that it cannot be removed without damaging the moulding and/or the profile (e.g. by tearing off the profile protrusion). To this end, the profile protrusions can for example be dovetail-like or generally designed with a cross-section which increases towards the protrusion end. An anchoring foot can alternatively or additionally be provided with barbs, undercuts and the like.

The term “profile base” in this case means the part of the sealing profile which faces the moulding after anchoring of the sealing profile and on which the at least one anchoring foot is arranged, where applicable. The term “profile back” means the part of the sealing profile which lies substantially opposite the profile base and, in the finished moulding, provides the sealing face which, for example in the case of tubbing elements for tunnel construction, bears against the profile back of a sealing profile in an adjacent moulding. The term “profile flank” means lateral regions of the sealing profile which lie between the profile base and the profile back. The term “rear flank part” refers to the part of a profile flank which lies further towards the profile back, while the term “base-side flank part” refers to the part of a profile flank which lies closer to the profile base.

The expression that the sealing profile “has fibres which extend beyond the profile region surface” means that the fibres are anchored at one end in a region of the sealing profile, for example in the profile base, or in an adhesive layer on a profile region surface, and project at the other end beyond the profile region surface towards the future moulding or extend from a region of the sealing profile or from an adhesive layer applied thereto towards the (future) moulding. The fibres are preferably substantially perpendicular to the profile region surface. “Substantially perpendicular” means that at least the majority, preferably at least 80, 85, 90 or 95%, of the fibres form with their longitudinal axes an angle of approximately 90°±5°, 90°±10°, 90°±15° or 90°±20° to the profile region surface.

When it is mentioned here that the fibres are provided in a portion of the profile region, this also means that the fibres can be provided in two or more non-contiguous regions of the profile region. The portion with the fibres can therefore also be discontinuous.

The fibres are arranged in at least one region of the sealing profile which is brought into contact with the moulding, where applicable indirectly via an adhesive layer, after embedding.

As already stated, the sealing profile according to the invention can also be anchored in the moulding solely via the fibres. It is therefore not absolutely necessary to provide one or more anchoring feet. In this embodiment, the sealing profile is connected to the moulding only by a plurality of connections produced at points via the fibres. This is preferred for example in the case of an annular seal for plastic pipes or pipe couplings which are anchored in the pipe wall or coupling wall by means of the fibres. In one embodiment of the invention, however, the sealing profile has at least one anchoring foot in the profile region which later faces the moulding, to anchor the sealing profile in the moulding. In this embodiment, which is preferred in particular for strand-like sealing profiles as are often used for tunnel tubbing elements, for example, the fibres are used in addition to the at least one, generally continuous anchoring foot for additional anchoring of the sealing profile in the moulding, in particular to prevent or reduce displacements of the sealing profile in the longitudinal plane of the profile.

If the sealing profile according to the invention has two or more mutually spaced anchoring feet, for example anchoring feet each arranged laterally to the profile longitudinal axis, in the profile region which later faces the moulding, the fibres are preferably arranged in the profile region between the anchoring feet. If there are more than two anchoring feet, it is preferred to provide fibres between all the adjacent anchoring feet. However, this is not necessary in every case, i.e. it is also possible in the case of three anchoring feet, for example, for fibres to be provided only between two adjacent anchoring feet.

The fibres can be fixedly connected to the profile region either directly or indirectly. A direct connection can be produced, for example, by embedding the fibres at one end into the profile region. This can be done during production of the profile, for example, by including the fibres in the vulcanisation process. An indirect connection can be produced by means of an adhesive layer on the profile region, into which adhesive layer the fibres are embedded at one end. This can be done for example by means of electronic flocking. The fibres can consist, for example, of metal, glass, cotton or plastic, for example polyamide, polyester or aramid. The fibres preferably have substantially the same length. Suitable fibre lengths can be determined simply by a person skilled in the art. The fibre length can be, for example, 0.5-12 mm, preferably 1-10, 1-7, 1-5, 1-4 or 1-3 mm. The type, cross-section, length and penetration depth of the fibres can be selected and adjusted by a person skilled in the art depending on the purpose in question and taking into account the expected forces to be absorbed.

The sealing profile preferably consists of an elastomer material, preferably of EPDM, SBR, CR or NBR, preferably NBR, the elastomer material preferably having a Shore hardness of 60-80°.

In an embodiment of the invention particularly suitable for tunnel tubbing elements, the profile region comprises a profile base having a profile base surface which faces the moulding after the sealing profile has been embedded, and at least one profile flank with a base-side flank part having a flank part surface which faces the moulding after the sealing profile has been embedded, wherein the profile base has, at least in a portion, fibres which are fixedly connected to the profile base and extend beyond the profile base surface, and/or the base-side flank part has, at least in a portion, fibres which are fixedly connected to the base-side flank part and extend beyond the flank part surface. Such sealing profiles often have one, two or more anchoring feet for anchoring the sealing profile in the moulding. In this case, it is preferred to arrange fibres between at least two of the anchoring feet.

In a second aspect, the present invention also relates to a sealing arrangement comprising a moulding consisting of curable material, in particular a concrete or plastic moulding, and a sealing profile according to the first aspect of the invention embedded therein, wherein the fibres are fixedly connected to the sealing profile at one end and fixedly connected to the moulding at the other end. “Fixedly connected to the sealing profile at one end and fixedly connected to the moulding at the other end” means that the fibres are fixedly connected at one end to a region of the sealing profile, whether by means of an adhesive layer on the profile region surface, into which adhesive layer the fibres are embedded at one end, or by means of direct embedding of the fibre ends into the matrix of the profile region, e.g. of the profile base, itself, and embedded at the opposite end (as seen in the longitudinal direction of the fibres) in the moulding, i.e. are surrounded by the cured material of the moulding.

In the sealing arrangement according to the invention, a sealing profile according to the invention is anchored in the moulding via a plurality of connections formed at points by the fibres. It is possible for the sealing profile to be anchored in the moulding only via the fibres or additionally with one or more anchoring feet.

The moulding can be, for example, a concrete tubbing element for tunnel construction, a concrete ring for a shaft or a concrete pipe (section), e.g. for sewer or pipeline construction, or a plastic pipe, for example a GRP pipe.

The invention is explained in more detail below using the attached figures, which are merely for illustration purposes.

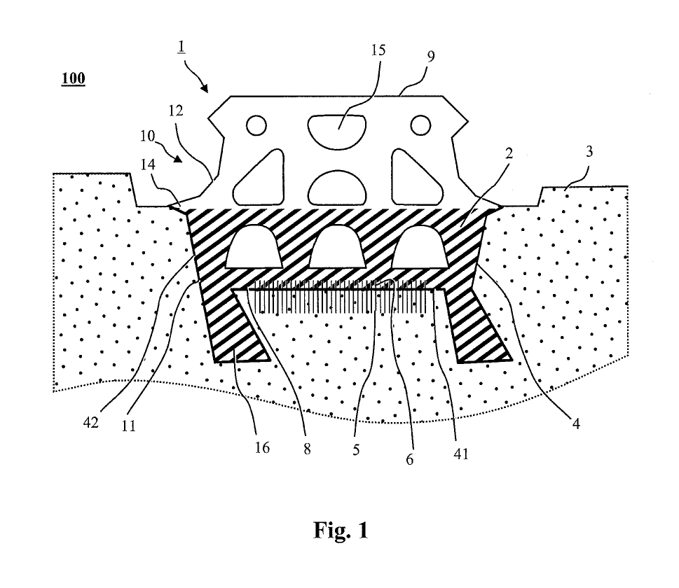

FIG. 1 is a schematic diagram of an embodiment of a sealing profile according to the invention, embedded into a moulding.

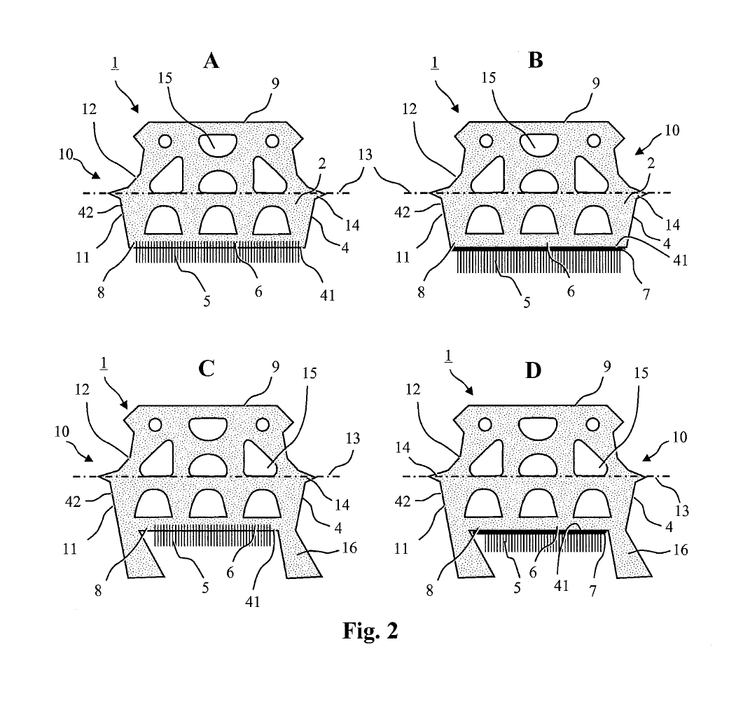

FIG. 2 is a schematic diagram of embodiments of a sealing profile according to the invention in cross-section. A. Embodiment without anchoring feet, with fibres embedded during vulcanisation. B. Embodiment without anchoring feet, with fibres connected to the profile base via an adhesive layer. C. Embodiment with anchoring foot, with fibres embedded during vulcanisation. D. Embodiment with anchoring foot, with fibres connected to the profile base via an adhesive layer.

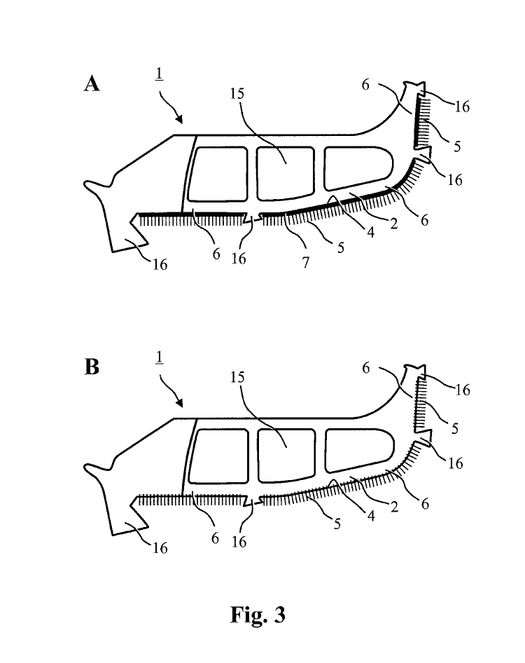

FIG. 3 schematically shows an embodiment of a sealing profile according to the invention for concrete pipes or shafts. A. Embodiment with anchoring feet, with fibres connected to the profile via an adhesive layer. B. Embodiment with anchoring feet, with fibres embedded directly into the profile.

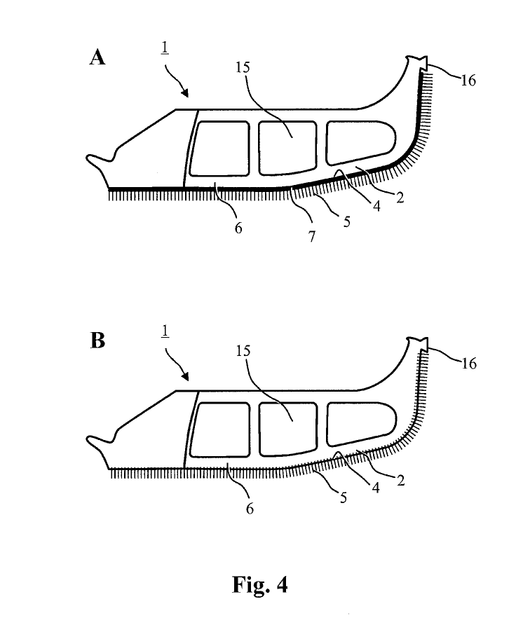

FIG. 4 schematically shows a further embodiment of a sealing profile according to the invention for concrete pipes or shafts. A. Embodiment with fibres connected to the profile via an adhesive layer. B. Embodiment with fibres embedded directly into the profile.

FIG. 1 schematically shows a sealing arrangement 100 comprising a sealing profile 1, as also shown in FIG. 1C, and a moulding 3, in this case a concrete tubbing element for tunnel construction, of which only a detail is shown.

The sealing profile 1, which has a generally hexagonal cross-section in this case and consists of an elastomer material, has a profile region 2 (shown crosshatched here) having a profile region surface 4 facing the moulding 3. The profile region 2 comprises a profile base 8 having a profile base surface 41 and base-side profile flank parts 11 of the lateral profile flanks 10 having a profile flank surface 42. The sealing profile 1 has a profile back 9 opposite the profile base 8 and rear flank parts 12. Fibres 5 are embedded at one end directly in the sealing profile 1, i.e. in a portion 6 of the profile region 2, in this case the profile base 8. In the embodiment provided here with two dovetail-like, mutually spaced anchoring feet 16, the portion 6 with the fibres 5 lies in the region of the profile base 8, between the anchoring feet 16. The sealing profile 1 has longitudinal channels 15 which run in the longitudinal direction of the sealing profile 1, as is also known in profiles from the prior art.

In the sealing profile 1 shown here, there are flank-side sealing lips 14, which are each arranged at the level of the plane 13 (see FIG. 2) above which the rear flank parts 12 and below which the base-side flank parts 11 lie in the diagram. The sealing profile 1 is in this case surrounded by the curable material, for example concrete, on the base side as far as the sealing lips 14. In the embodiment shown here, the sealing profile 1 is anchored both via the anchoring feet 16 and via the fibres 5. By means of their connection at points to the moulding 3, the fibres 5 prevent or impede displacement of the sealing profile 1 in the longitudinal direction thereof, i.e. in the direction perpendicular to the plane of the paper.

FIG. 2 schematically shows different embodiments of a sealing profile 1 according to the invention in cross-section. FIG. 2A shows an embodiment of a sealing profile 1 according to the invention without anchoring feet 16, with fibres 5 vulcanised directly into the profile base 8. FIG. 2B shows an embodiment of a sealing profile 1 according to the invention without anchoring feet 16, with fibres 5 connected to the profile base 8 via an adhesive layer 7. FIG. 2C shows the embodiment of a sealing profile 1 according to the invention shown embedded into a moulding 3 in FIG. 1, with two anchoring feet 16 and fibres 5 embedded during vulcanisation. FIG. 2D shows an embodiment of a sealing profile 1 according to the invention with anchoring feet 16 and with fibres 5 connected to the profile base 8 via an adhesive layer 7. In each case, cross-sections through a strand-like sealing profile 1 are shown, i.e. sections transverse to the longitudinal axis of the strand-like sealing profile 1, which must be imagined as extending above and below the plane of the paper.

The embodiments shown in FIGS. 2A and 2B do not have any anchoring feet 16. The embodiments shown in FIGS. 2C and 2D have two, in this case dovetail-like, mutually spaced anchoring feet 16 which extend from the profile base 8. Fibres 5 are embedded at one end either directly into the profile base 8 (FIGS. 2A, C) or into an adhesive layer 7 (FIG. 2B, D) on the profile base surface 41. In embodiments with anchoring feet 16 (FIGS. 2C, D), the fibres 5 are arranged in the region of the profile base 8 between the anchoring feet 16. The sealing profiles 1 have longitudinal channels 15 which run in the longitudinal direction of the sealing profile 1, as is also known in profiles from the prior art.

FIG. 3 shows a cross-section through an embodiment of a sealing profile 1 according to the invention which is particularly suitable for concrete pipes or shafts. The sealing profile 1 in this case has anchoring feet 16 and fibres 5, with the aid of which the sealing profile 1 can be embedded into a concrete pipe sleeve (not shown). The fibres 5 are either connected to the profile region 2 which faces the subsequent moulding 3, i.e. the concrete pipe sleeve, by means of an adhesive layer 7 on the profile region surface 4 (see FIG. 3A) or directly embedded into the profile region 2 (see FIG. 3B). The fibres 5 are arranged in portions 6 of the profile region 2 between the anchoring feet 16. In this case too, longitudinal channels 15 are present in the sealing profile 1.

FIG. 4 shows a cross-section through a further embodiment of a sealing profile 1 according to the invention which is particularly suitable for concrete pipes or shafts. In this case, the fibres 5 provided over an extended portion 6 are used substantially to anchor the sealing profile 1. The only anchoring foot 16 still present in the edge region of the sealing profile 1 is used substantially to prevent the ingress of liquid concrete during casting of the moulding 3. In this embodiment too, the fibres 5 are either connected to the profile region 2 which faces the subsequent moulding 3, i.e. the concrete pipe sleeve, by means of an adhesive layer 7 on the profile region surface 4 (see FIG. 4A) or directly embedded into the profile region 2 (see FIG. 4B).

1. A sealing profile for embedding into a moulding of curable material, wherein the sealing profile (1) has a profile region (2) having a profile region surface (4) which faces the moulding (3) after the sealing profile (1) has been embedded, and wherein the sealing profile (1) has, at least in a portion (6) of the profile region (2), fibres (5) which are fixedly connected to the sealing profile (1) and extend beyond the profile region surface (4).

2. The sealing profile according to claim 1, wherein the fibres (5) are fixedly connected to the sealing profile (1) indirectly by means of an adhesive layer (7) on the profile region surface (4) of the profile region (2) or directly by embedding into the profile region (2).

3. The sealing profile according to claim 1, wherein the sealing profile (1) has, in the profile region (2), at least one anchoring foot (16) for anchoring the sealing profile (1) in the moulding (3).

4. The sealing profile according to claim 1, wherein the sealing profile (1) has, in the profile region (2), two or more mutually spaced anchoring feet (16) and one or more portions (6) with fibres (5) between each pair of adjacent anchoring feet (16).

5. The sealing profile according to claim 1, wherein the sealing profile (1) consists of an elastomer material, and wherein the elastomer material has a Shore hardness of 60-80°.

6. The sealing profile according to claim 1, wherein the fibres are metal, glass, cotton or plastic fibres.

7. The sealing profile according to claim 1, for tunnel tubbing elements, wherein the profile region (2) comprises a profile base (8) having a profile base surface (41) which faces the moulding (3) after the sealing profile (1) has been embedded, and at least one profile flank (10) with a base-side flank part (11) having a flank part surface (42) which faces the moulding (3) after the sealing profile (1) has been embedded, and wherein the profile base (8) has, at least in a portion (6), fibres (5) which are fixedly connected to the profile base and extend beyond the profile base surface (41), and/or the base-side flank part (11) has, at least in a portion (6), fibres (5) which are fixedly connected to the base-side flank part (11) and extend beyond the flank part surface (42).

8. A sealing arrangement comprising a moulding (3) consisting of curable material and a sealing profile (1) according to claim 1 embedded therein, wherein the fibres (5) are fixedly connected at one end to the sealing profile (1) and fixedly connected at the other end to the moulding (3).

9. The sealing arrangement according to claim 8, wherein the moulding (3) is a concrete or plastic moulding.

10. A sealing profile for embedding into a concrete or plastic moulding, wherein the sealing profile (1) has a profile region (2) having a profile region surface (4) which faces the concrete or plastic moulding (3) after the sealing profile (1) has been embedded, and wherein the sealing profile (1) has, at least in a portion (6) of the profile region (2), fibres (5) which are fixedly connected to the sealing profile (1) and extend beyond the profile region surface (4).

11. The sealing profile according to claim 1, wherein the sealing profile (1) consists of an elastomer material selected from EPDM, SBR, CR and NBR, and wherein the elastomer material has a Shore hardness of 60-80°.

12. The sealing profile according to claim 1, wherein the fibres are polyamide, polyester or aramid fibres.

13. The sealing arrangement according to claim 8, wherein the moulding (3) is a concrete tubbing element for tunnel construction, a concrete ring for shaft structures, a concrete pipe for sewer or pipeline construction or a plastic pipe.

14. The sealing arrangement according to claim 8, wherein the moulding (3) is a GRP pipe.
